(19) United States
(12) Patent Application Publication
(10) Pub. No.: US 2010/0238106 A1
(43) Pub. Date: Sep. 23, 2010

(54) Driving Method for Electrophoretic Display Panel and Electrophoretic Display Apparatus using the same

(75) Inventors: Heng-Hao Chang, Hsinchu (TW); Chun-Ta Chien, Hsinchu (TW)

Correspondence Address: Portal IPR Services, P.O. Box 223205, Chantilly, VA, 20153, US

(73) Assignee: Prime View International Co., Ltd.

(21) Appl. No.: 12/632,803

(22) Filed: Dec. 8, 2009

(30) Foreign Application Priority Data
Mar. 20, 2009 (TW) 098109154

(51) Int. Cl. G09G 3/34

(52) U.S. Cl. 345/107

(57) ABSTRACT

A driving method for an electrophoretic display panel and an electrophoretic display apparatus using the same are provided. The electrophoretic display apparatus comprises the electrophoretic display panel and a gate driver. The driving method comprises the following steps: employing a gate driver to output gate-driving signals to the electrophoretic display panel for enabling the electrophoretic display panel to perform an image-updating operation; enabling the gate driver to stop outputting the gate-driving signals to the electrophoretic display panel in a period after performing the image-updating operation and before performing a next image-updating operation.

This application claims the priority benefit of Taiwan application serial no. 098109154, filed on Mar. 20, 2009.

### BACKGROUND

1. Field of the Invention

The present invention relates to the technology of the display field and, more particularly, to a driving method for an electrophoretic display panel and an electrophoretic display apparatus using the same.

2. Description of the Related Art

FIG. 1 is a schematic view of an electrophoretic display apparatus. Referring to FIG. 1, the electrophoretic display apparatus 100 includes a source driver 102, a gate driver 104 and an electrophoretic display panel 106. The source driver 102 is coupled to the electrophoretic display panel 106 via a plurality of source lines 108, and the gate driver 104 is coupled to the electrophoretic display panel 106 via a plurality of gate lines 110. The electrophoretic display panel 106 includes a plurality of pixels 112, and each of the pixels 112 is coupled to a corresponding one of the source lines 108 and a corresponding one of the gate lines 110.

FIG. 2 illustrates an equivalent circuit of a pixel 112 as shown in FIG. 1 and coupling relations thereof. Referring to FIG. 2, the pixel 112 includes a MOS (metal-oxide semiconductor) transistor 114, a pixel capacitance C_{LC} and a storage capacitance C_{ST}. A gate electrode and a source electrode of the MOS transistor 114 are coupled to the corresponding one of the gate lines 110 and the corresponding one of the source lines 108 respectively, and a drain electrode of the MOS transistor 114 is coupled to a common potential V_{COM} via the pixel capacitance C_{LC} and the storage capacitance C_{ST}. In addition, the pixel 112 further includes parasitic capacitances, which are marked by labels 116, 118 and 120 respectively.

FIG. 3 illustrates a gate-driving signal outputted from the gate driver 104 as shown in FIG. 1 to the corresponding one of the gate lines 110. Referring to FIGS. 2 and 3 for describing an update method for updating the display content of the pixel 112. When the display content of the pixel 112 as shown in FIG. 2 needs to be updated, the gate driver 104 enables the gate-driving signal S_{G} to be changed from a negative potential (that is lower than zero volt) to a positive potential (that is larger than zero volt), and then enables the gate-driving signal S_{G} to be changed from the positive potential to the negative potential to form a pulse 302. Thus the MOS transistor 114 is turned on in the enable period T of the pulse 302. The source driver 102 transmits a source-driving signal (not shown) via the corresponding one of the source lines 108 in the enable period T of the pulse 302. Thus a new display data is written into the pixel 112 by the source-driving signal to update the display content of the pixel 112.

In summary, the display content of each of the pixels 112 of the electrophoretic display panel 106 is updated by the above update method, such that a whole image displayed by the electrophoretic display panel 106 is updated. In a period after updating the image and before updating a next image, the gate driver 104 keeps all of the gate-driving signals outputted therefrom at the negative potential, and the source driver 102 keeps all of the source-driving signals outputted therefrom at zero volt.

Continuedly referring to FIGS. 2 and 3, the pixel 112 has a memory capability. That is, even if the pixel 112 does not receive any driving signal after updating the display content, the pixel 112 still maintains the original display data. Thus the electrophoretic display panel 106 can keep presenting the original image. Therefore, the driving signal is provided to the pixel 112 only when updating the image displayed by the electrophoretic display panel 106. However, in the above update method, since the gate driver 104 still keeps the gate-driving signals at the negative potential when not updating the image, the negative potential still can influence the voltage distribution of the inner capacitance of the pixel 112 to further influence the display image via the corresponding one of the gate lines 110 and various parasitic capacitances of the pixel 112. In addition, since the negative potential is still provided to the gate of the MOS transistor 114 after updating the image, the MOS transistor 114 is easy to become aging.

### BRIEF SUMMARY

The present invention relates to a driving method for an electrophoretic display panel, which enables the electrohporetic display panel to prevent the problem of influencing the display image.

The present invention relates to an electrophoretic display apparatus using the driving method, which will not have the problem of influencing the display image displayed by an electrophoretic display panel thereof.

A driving method for an electrophoretic display panel in accordance with an exemplary embodiment of the present invention is provided. The driving method comprises the following steps: employing a gate driver to output gate-driving signals to the electrophoretic display panel for enabling the electrophoretic display panel to perform an image-updating operation; enabling the gate driver to stop outputting the gate-driving signals to the electrophoretic display panel in a period after performing the image-updating operation and before performing a next image-updating operation.

An electrophoretic display apparatus in accordance with another exemplary embodiment of the present invention is provided. The electrophoretic display apparatus comprises an electrophoretic display panel and a gate driver. The gate driver is coupled to the electrophoretic display panel for outputting gate-driving signals to the electrophoretic display panel for enabling the electrophoretic display panel to perform an image-updating operation. Furthermore, the gate driver stops outputting the gate-driving signals to the electrophoretic display panel in a period after performing the image-updating operation and before performing a next image-updating operation.

In an exemplary embodiment of the present invention, the way of enabling the gate driver to stop outputting the gate-driving signals comprises stopping providing a working power supply to the gate driver.

In an exemplary embodiment of the present invention, the way of enabling the gate driver to stop outputting the gate-driving signals comprises disconnecting an inner kernel circuit of the gate driver from outer output-terminals of the gate driver for enabling the outer output-terminals in a floating state. The aforementioned inner kernel circuit is configured for generating the gate-driving signals, and the aforementioned outer output-terminals are coupled to the electrophoretic display panel.

In an exemplary embodiment of the present invention, the way of enabling the gate driver to stop outputting the gate-driving signals comprises enabling the gate driver to output the gate-driving signals which voltage values are zero.

The present invention employs the gate driver to output the gate-driving signals to the electrophoretic display panel for enabling the electrophoretic display panel to perform the image-updating operation, and enables the gate driver to stop outputting the gate-driving signals to the electrophoretic display panel in the period after performing the image-updating operation and before performing the next image-updating operation. Therefore, in the period after performing the image-updating operation and before performing the next image-updating operation, the gate driver will not output any signal to influence the voltage distribution of inner capacitances of pixels, thus the display image displayed by the electrophoretic display panel will not be influenced.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of an electrophoretic display apparatus.

FIG. 2 illustrates an equivalent circuit of a pixel 112 as shown in FIG. 1 and coupling relations thereof.

FIG. 3 illustrates a gate-driving signal outputted from a gate driver 104 as shown in FIG. 1 to a corresponding one of the gate lines 110.

FIG. 4 is a schematic view of an electrophoretic display apparatus in accordance with an exemplary embodiment of the present invention.

FIG. 5 is a schematic view of an electrophoretic display apparatus in accordance with another exemplary embodiment of the present invention.

FIG. 6 is a schematic view of an electrophoretic display apparatus in accordance with still another exemplary embodiment of the present invention.

FIG. 7 illustrates gate-driving signals outputted from the gate driver 604 as shown in FIG. 6.

FIG. 8 illustrates a main flow chart of a driving method in accordance with an exemplary embodiment of the present invention.

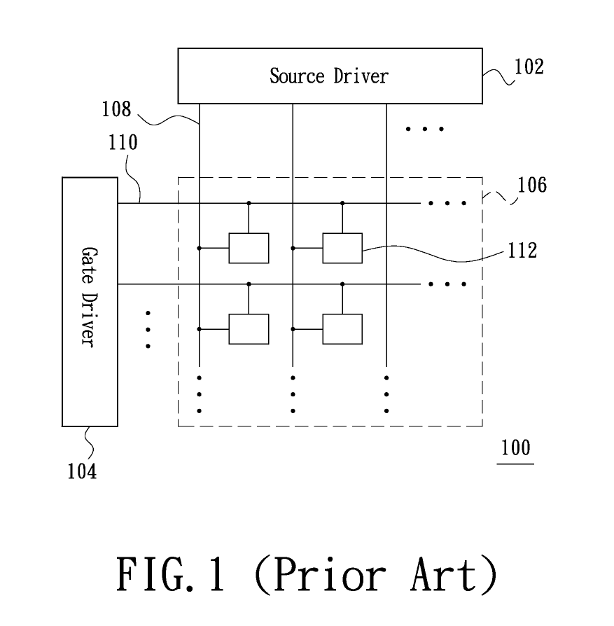

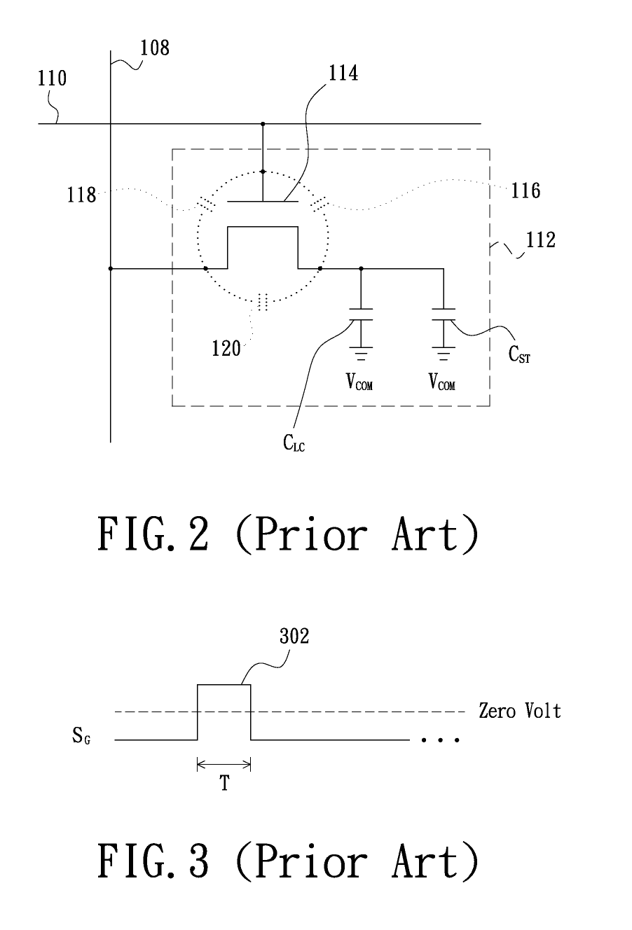

### DETAILED DESCRIPTION

Reference will now be made to the drawings to describe exemplary embodiments of the present driving method and the present electrophoretic display apparatus, in detail. The following description is given by way of example, and not limitation.

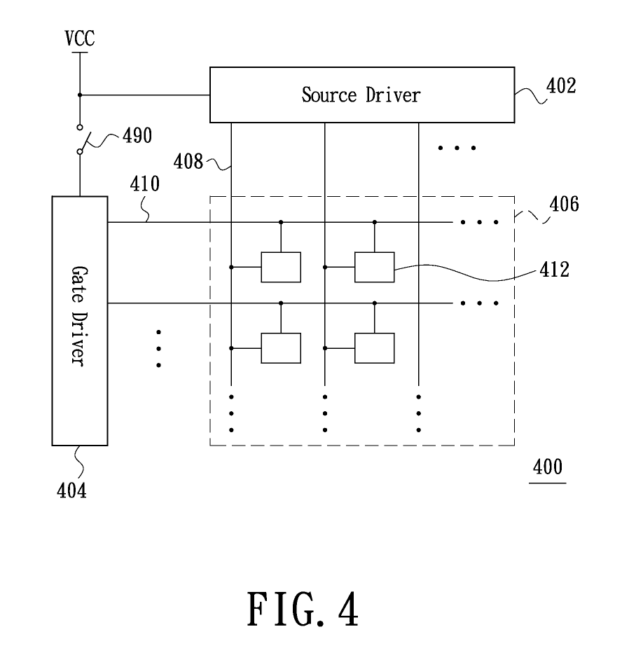

FIG. 4 is a schematic view of an electrophoretic display apparatus in accordance with an exemplary embodiment of the present invention. Referring to FIG. 4, the electrophoretic display apparatus 400 includes a source driver 402, a gate driver 404 and an electrophoretic display panel 406. The source driver 402 is coupled to the electrophoretic display panel 406 via a plurality of source lines 408, and the gate driver 404 is coupled to the electrophoretic display panel 406 via a plurality of gate lines 410. The electrophoretic display panel 406 has a plurality of pixels 412, and each of the pixels 412 is coupled to a corresponding one of the source lines 408 and a corresponding one of the gate lines 410. In addition, a label VCC as shown in FIG. 4 represents a working power supply produced by the electrophoretic display apparatus 400 therein, and a label 490 as shown in FIG. 4 represents a switch. When the source driver 402 and the gate driver 404 receive the working power supply VCC, the source driver 402 and the gate driver 404 start to operate normally for outputting source-driving signals and gate-driving signals respectively.

When the electrophoretic display panel 406 needs to perform an image-updating operation, the electrophoretic display panel 406 will turn on the switch 490 for enabling the gate driver 404 to receive the working power supply VCC and to operate normally. Therefore, the gate driver 404 outputs the gate-driving signals to the electrophoretic display panel 406, and the source driver 402 correspondingly outputs the source-driving signals to write new display data into the pixels 412 of the electrophoretic display panel 406, such that the electrophoretic display panel 406 performs the image-updating operation. However, in a period after performing the image-updating operation and before performing a next image-updating operation, the electrophoretic display apparatus 400 will turn off the switch 490 for enabling the gate driver 404 not to receive the working power supply VCC and not to operate normally, thus the gate driver 404 stops outputting the gate-driving signals to the electrophoretic display panel 406. Furthermore, the source driver 402 enables the voltage values of the source-driving signals to be kept at zero during the period.

In other words, the manner used in this exemplary embodiment is to enable the electrophoretic display apparatus 400 to stop providing the working power supply VCC to the gate driver 404 in the period after performing the image-updating operation and before performing the next image-updating operation. Therefore, the gate driver 404 does not output any signal to influence the voltage distribution of inner capacitances of the pixels 412 in the period after performing the image-updating operation and before performing the next image-updating operation, thus the display image displayed by the electrophoretic display panel 406 will not be influenced.

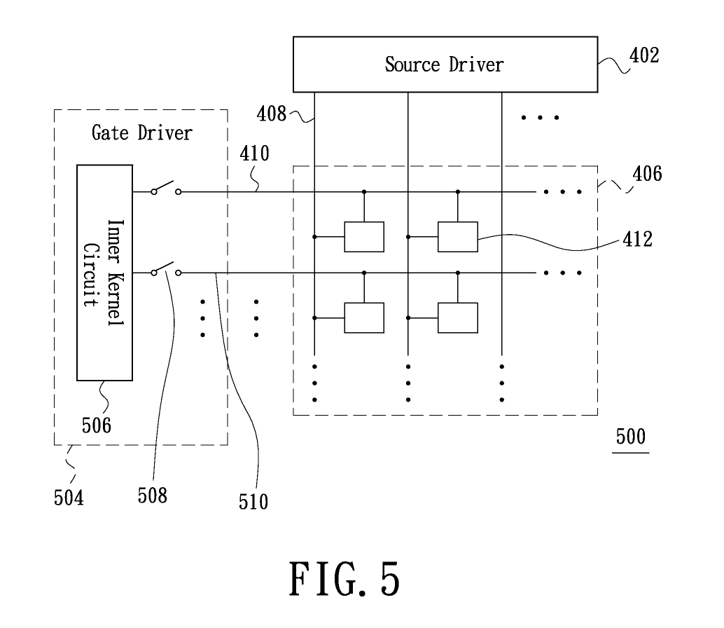

FIG. 5 is a schematic view of an electrophoretic display apparatus in accordance with another exemplary embodiment of the present invention. Referring to FIG. 5, the electrophoretic display apparatus 500 is similar with the electrophoretic display apparatus 400 as shown in FIG. 4, except that the electrophoretic display apparatus 500 does not include a switch arranged between the gate driver 504 and a working power supply (not shown), and includes a plurality of switches arranged in the gate driver 504. As shown in FIG. 5, the gate driver 504 includes an inner kernel circuit 506, a plurality of switches 508 and a plurality of outer output-terminals 510. The switches 508 are set additionally. The inner kernel circuit 506 is configured for generating the gate-driving signals, and the outer output-terminals 510 are coupled to the electrophoretic display panel 406 via the corresponding gate lines 410.

When the electrophoretic display panel 406 needs to perform the image-updating operation, the gate driver 504 will turn on all of the switches 508 to normally transmit the gate-driving signals generated by the inner kernel circuit 506 to the electrophoretic display panel 406. At the moment, the source driver 402 correspondingly outputs the source-driving signals to write the new display data into the pixels 412 of the electrophoretic display panel 406 for enabling the electrophoretic display panel 406 to perform the image-updating operation. In the period after performing the image-updating operation and before performing the next image-updating operation, the gate driver 504 will turn off all of the switches 508, such that the gate-driving signals generated by the inner kernel circuit 506 cannot be transmitted to the outer output-terminals 510. Thus the gate driver 504 stops outputting the gate-driving signals to the electrophoretic display panel 406. Furthermore, the source driver 402 enables the voltage values of the source-driving signals to be kept at zero during the period.

In other words, the manner used in this exemplary embodiment is to disconnect the inner kernel circuit 506 of the gate driver 504 from the outer output-terminals 510 of the gate driver 504 in the period after performing the image-updating operation and before performing the next image-updating operation, such that the outer output-terminals 510 of the gate driver 504 are in a floating state. Therefore, since the gate driver 504 does not output any signal to influence the voltage distribution of the inner capacitances of the pixels 412 in the period after performing the image-updating operation and before performing the next image-updating operation, the display image displayed by the electrophoretic display panel 406 will not be influenced.

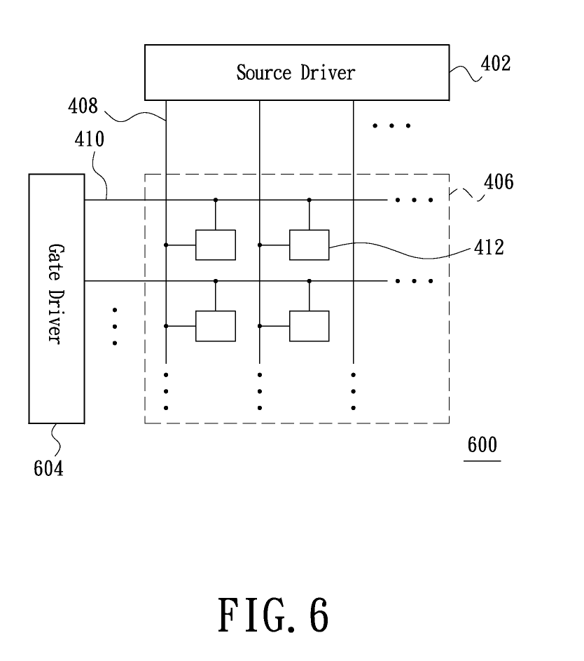

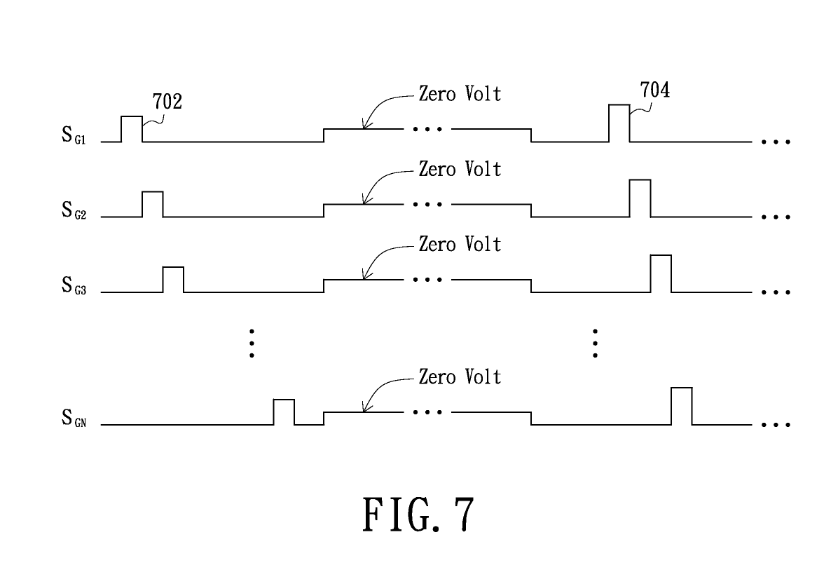

FIG. 6 is a schematic view of an electrophoretic display apparatus in accordance with still another exemplary embodiment of the present invention. Referring to FIG. 6, the electrophoretic display apparatus 600 is similar with the electrophoretic display apparatus 400 as shown in FIG. 4, except that the electrophoretic display apparatus 600 does not include a switch arranged between the gate driver 604 and a working power supply (not shown), and enables the gate driver 604 to output specific gate-driving signals as shown in FIG. 7. FIG. 7 illustrates the gate-driving signals outputted from the gate driver 604 as shown in FIG. 6. Referring to FIG. 7, assuming the gate driver 604 is coupled to N gate lines 410 and N is a positive integer, signals S_{G1}, S_{G2}, S_{G3}˜S_{GN} are the gate-driving signals outputted from the gate driver 604 to the N gate lines 410. In FIG. 7, the gate-driving signals S_{G1}, S_{G2}, S_{G3}˜S_{GN} present pulses (as marked by a label 702) in sequence, which are a period for the electrophoretic display panel 406 performing an image-updating operation. After the electrophoretic display panel 406 performing the image-updating operation, all of the gate-driving signals are kept at zero until the electrophoretic display panel 406 performs the next image-updating operation, i.e. the gate-driving signals S_{G1}, S_{G2}, S_{G3}˜S_{GN} present pulses (as marked by a label 707) in sequence again. In addition, when the electrophoretic display panel 406 needs to perform the image-updating operation, the source driver 402 correspondingly outputs the source-driving signals to write the new display data into the pixels 412 of the electrophoretic display panel 406, thus the electrophoretic display panel 406 performs the image-updating operation. However, the source driver 402 also enables the voltage values of the source-driving signals to be kept at zero during the period after performing the image-updating operation and before performing the next image-updating operation.

In other words, the manner used in this exemplary embodiment is to enable the gate driver 604 to output the gate-driving signals which voltage values are zero during the period after performing the image-updating operation and before performing the next image-updating operation. Therefore, since the gate driver 604 only outputs the gate-driving signals which voltage values are zero during the period after performing the image-updating operation and before performing the next image-updating operation, the display image displayed by the electrophoretic display panel 406 will not be influenced.

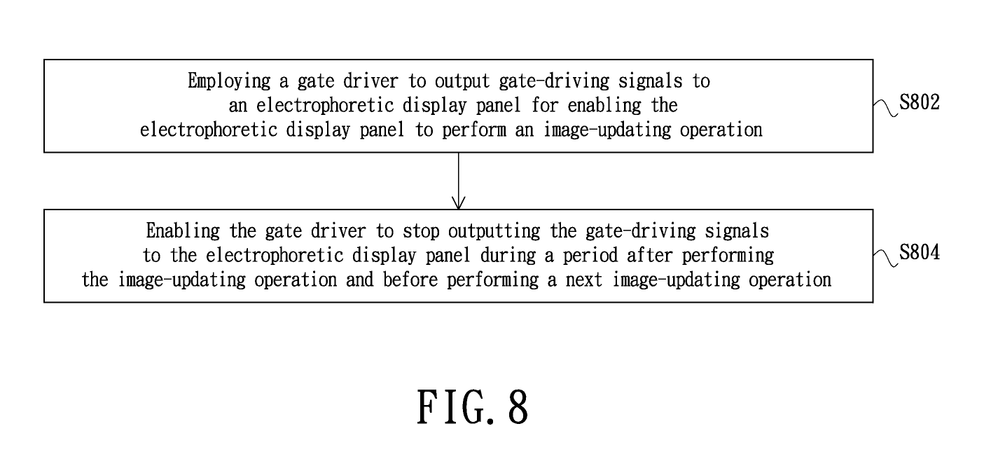

A driving method for an electrophoretic display panel may be summarized from the above exemplary embodiments of the present invention, which is shown in FIG. 8. FIG. 8 illustrates a main flow chart of the driving method in accordance with an exemplary embodiment of the present invention. The driving method includes the following steps: employing the gate driver to output the gate-driving signals to the electrophoretic display panel for enabling the electrophoretic display panel to perform the image-updating operation (as shown in the step S802); enabling the gate driver to stop outputting the gate-driving signals to the electrophoretic display panel during the period after performing the image-updating operation and before performing the next image-updating operation (as shown in a step S804).

Of course, in the step 5804 the way of enabling the gate driver to stop outputting the gate-driving signals may be stopping providing the working power supply to the gate driver, or disconnecting the inner kernel circuit (configured for generating the gate-driving signals) of the gate driver from the outer output-terminals (coupled to the electrophoretic display panel) of the gate driver for enabling the output-terminals of the gate driver to be in the floating state. In addition, in step S804 the way of enabling the gate driver to stop outputting the gate-driving signals may be enabling the gate driver to output the gate-driving signals which voltage values are zero.

In summary, the present invention employs the gate driver to output the gate-driving signals to the electrophoretic display panel for enabling the electrophoretic display panel to perform the image-updating operation, and enables the gate driver to stop outputting the gate-driving signals to the electrophoretic display panel in the period after performing the image-updating operation and before performing the next image-updating operation. Therefore, in the period after performing the image-updating operation and before performing the next image-updating operation, the gate driver will not output any signal to influence the voltage distribution of the inner capacitances of the pixels, thus the display image displayed by the electrophoretic display panel will not be influenced.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A driving method for an electrophoretic display panel, comprising:
employing a gate driver to output gate-driving signals to the electrophoretic display panel for enabling the electrophoretic display panel to perform an image-updating operation; and
enabling the gate driver to stop outputting the gate-driving signals to the electrophoretic display panel in a period after performing the image-updating operation and before performing a next image-updating operation.

2. The driving method as claimed in claim 1, wherein the way of enabling the gate driver to stop outputting the gate-driving signals comprises stopping providing a working power supply to the gate driver.

3. The driving method as claimed in claim 1, wherein the way of enabling the gate driver to stop outputting the gate-driving signals comprises disconnecting an inner kernel circuit of the gate driver from outer output-terminals of the gate driver for enabling the outer output-terminals in a floating state, the aforementioned inner kernel circuit is configured for generating the gate-driving signals and the aforementioned outer output-terminals are coupled to the electrophoretic display panel.

4. The driving method as claimed in claim 1, wherein the way of enabling the gate driver to stop outputting the gate-driving signals comprises enabling the gate driver to output the gate-driving signals which voltage values are zero.

5. An electrophoretic display apparatus, comprising:
an electrophoretic display panel; and
a gate driver coupled to the electrophoretic display panel for outputting gate-driving signals to the electrophoretic display panel, wherein the gate-driving signals enable the electrophoretic display panel to perform an image-updating operation, and the gate driver stops outputting the gate-driving signals to the electrophoretic display panel in a period after performing the image-updating operation and before performing a next image-updating operation.

6. The electrophoretic display apparatus as claimed in claim 5, wherein the electrophoretic display apparatus stops providing a working power supply to the gate driver when the gate driver needs to stop outputting the gate-driving signals.

7. The electrophoretic display apparatus as claimed in claim 5, wherein the gate driver disconnects an inner kernel circuit thereof from outer output-terminals of the gate driver for enabling the outer output-terminals in a floating state when the gate driver needs to stop outputting the gate-driving signals, the aforementioned inner kernel circuit is configured for generating the gate-driving signals and the aforementioned outer output-terminals are coupled to the electrophoretic display panel.

8. The electrophoretic display apparatus as claimed in claim 5, wherein the gate driver outputs the gate-driving signals which voltage values are zero when the gate driver needs to stop outputting the gate-driving signals.
